(19) United States
(12) Patent Application Publication
(10) Pub. No.: US 2004/0207874 A1
(43) Pub. Date: Oct. 21, 2004

(54) PRINTER WITH DETACHABLE CONTROL DEVICE

(76) Inventor: Chi-Chan Chiang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,224

(22) Filed: Jul. 1, 2003

(30) Foreign Application Priority Data
Apr. 17, 2003 (TW) 092108994

(51) Int. Cl. G06F 15/00

(52) U.S. Cl. 358/1.16; 358/1.13

(57) ABSTRACT

A printer includes a first housing, a printing module installed on the first housing for printing data, and a controller. The controller includes a second housing that can be detached installed on the first housing, a processor installed in the second housing for processing programs and data, and a display panel installed on the second housing and electrically connected to the processor for displaying data.

### BACKGROUND OF INVENTION

1. Field of the Invention

The present invention relates to a printer, and more specifically, to a printer with a detachable control device.

2. Description of the Prior Art

Printers are indispensable output devices in todays information-oriented society. Conventional printers are used to print data onto paper. However, as information technology progresses, new models integrates various additional functions together. For instance, thermal transfer printers are capable of printing an image taken by a digital camera onto paper. Thermal transfer printers offer the advantage that users are able to select their favorite images or pictures to print, instead of developing the whole film as before, reducing costs and wasted resources.

However, while controlling a printer's operation, in addition to transferring data and commands through a host computer to the printer, new-model printers further apply new functions to process image data and execute printer commands independently of a host computer. Please refer to FIG. 1. FIG. 1 is a diagram illustrating a first printer 10 according to the prior art. The first printer 10 includes a card reader 12 for receiving image data from a memory card 14, and the memory card 14 conforms to standards such as CF, SD or MMC etc. The first printer 10 further includes a control button set 16 for controlling the operation of the first printer 10, an indicative light set 18 for reporting the condition of the first printer 10, and a large-size display panel 20 for displaying the image data. When printing out the image data in the memory card 14, users can insert the memory card 14 into the card reader 12 and select images to be printed by the control button set 16. The selected images are displayed on the display panel 20, and users can execute printer commands from the control button set 16. Error messages such as paper out, ink out, or print interrupted are reported by the indicative light set 18.

Although the conventional first printer 10 provides a function to read and print image data by the printer itself, users must stay in close proximity to the printer to monitor the display panel 20 and operate the control button set 16 in order to print out image data. It is inconvenient that the users are unable to remotely control the printer, and in addition, need to stay close to the display panel 20 to see the images to be printed. Additionally, the display panel 20 is required to be large-size and with high display quality. This is inconvenient to the user and also increases the cost of the display panel 20.

### SUMMARY OF INVENTION

It is therefore a primary objective of the present invention to provide a printer to solve the problems mentioned above.

Briefly summarized, a printer includes a first housing, a printing module installed on the first housing for printing data, and a controller. The controller includes a second housing that can be detached installed on the first housing, a processor installed in the second housing for processing programs and data, and a display panel installed on the second housing and electrically connected to the processor for displaying data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a first printer according to the prior art.

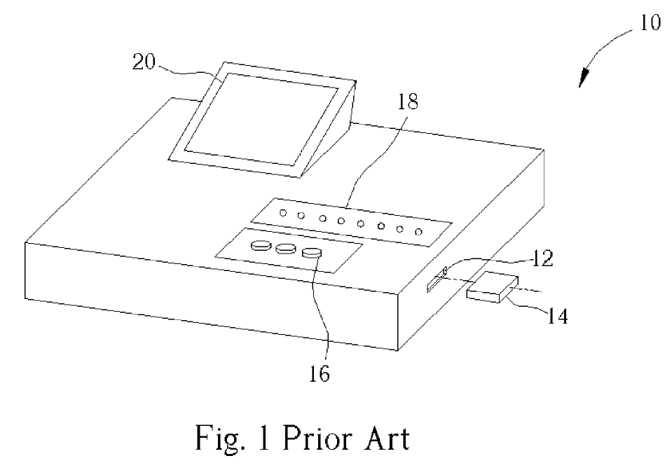

FIG. 2 is a diagram illustrating a second printer according to the first embodiment of the present invention.

FIG. 3 is a block diagram of the second printer shown in FIG. 2.

FIG. 4 is a diagram illustrating the first controller detached from the first housing.

FIG. 5 is a diagram illustrating a third printer according to the second embodiment of the present invention.

FIG. 6 is a block diagram of the third printer shown in FIG. 5.

FIG. 7 is a diagram illustrating a third controller according to another embodiment of the present invention.

FIG. 8 is a diagram illustrating a fourth controller according to another embodiment of the present invention.

### DETAILED DESCRIPTION

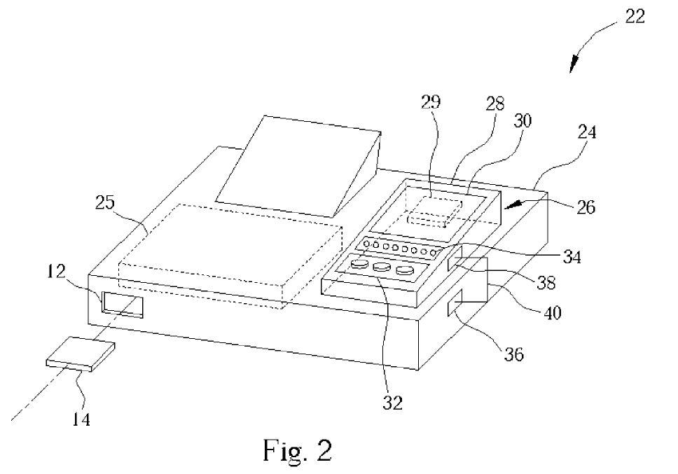

Please refer to FIG. 2. FIG. 2 is a diagram illustrating a second printer 22 according to the first embodiment of the present invention. The second printer 22 includes a first housing 24, a card reader 12 installed on the first housing 24 for receiving image data from a memory card 14, and a printing module 25 installed on the first housing 24 for printing data. The memory card 14 conforms to standards such as CF, SD or MMC etc. The second printer 22 further includes a first controller 26 which includes a second housing 28 that can be detached installed on the first housing 24, a processor 29 installed on the second housing 28 for processing programs and data, and a display panel 30 installed on the second housing and electrically connected to the processor 29 for displaying data. A touch panel can be installed on the display panel 30 for inputting control signals. The second printer 22 further includes a plurality of buttons 32 installed on the second housing 28 for inputting control commands, and a plurality of indicative lights 34 for reporting the condition of the second printer 22. The first housing 24 includes a first connecting port 36, and the second housing 28 includes a second connecting port 38. The second printer 22 includes a wire 40 connected between the first connecting port 36 and the second connecting port 38 for electrically connecting the printing module 25 to the processor 29 of the first controller 26. The first connecting port 36 and the second connecting port 38 conform to standards such as USB1.0, USB2.0 or IEEE1394.

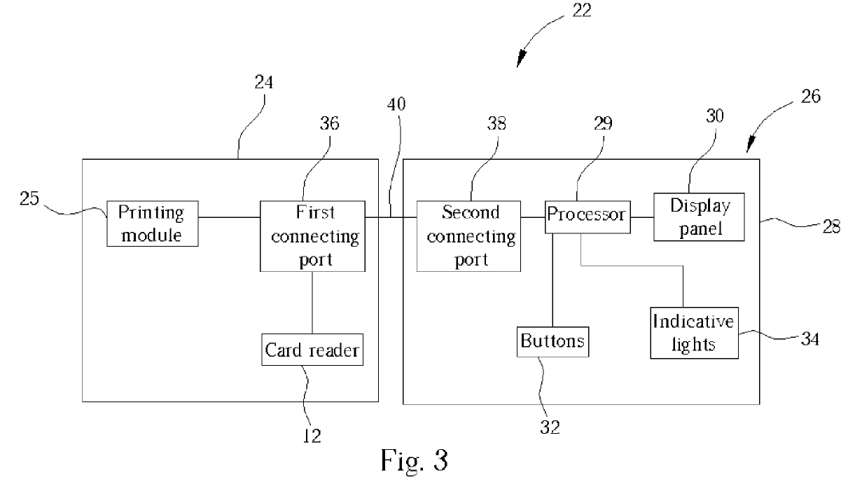

Please refer to FIG. 3. FIG. 3 is a block diagram of the second printer 22. When printing out the images in the memory card 14, users can insert the memory card 14 into the card reader 12 and select images to be printed by the buttons 32 on the first controller 26. The buttons 32 transmit a read signal to the processor 29, and the processor 29 reads the image data in the memory card 14 inserted in the card reader 12 through the first connecting port 36, the wire 40, and the second connecting port 38. The selected images are displayed on the display panel 30, and users can press the buttons 32 to transmit edit signals to the processor 29 in order to edit the images, such as cutting, rotating, resizing, and adjusting colors and brightness. By inputting a print command with the buttons 32, a print signal is then transmitted to the processor 29 so that the processor 29 transmits the print signal to the printing module 25 through the first connecting port 36, the wire 40, and the second connecting port 38. The processor 29 also transmits condition signals to the indicative lights 34 to report the condition of the second printer 22, such as printing, paper out, ink out, toner out, paper jam, print interrupted, etc.

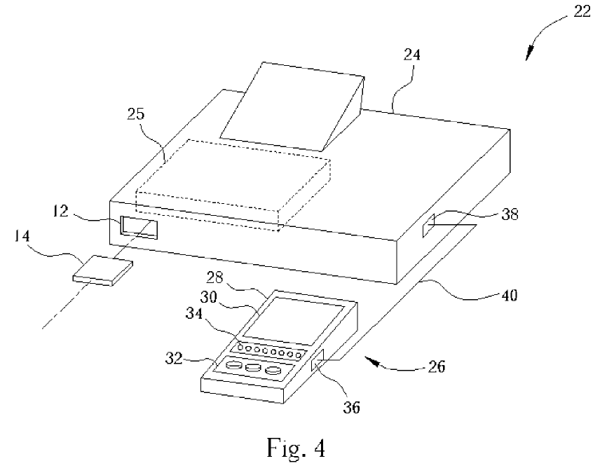

Please refer to FIG. 4. FIG. 4 is a diagram illustrating the first controller 26 detached from the first housing 24. As shown in FIG. 4, users can detach the first controller 26 from the first housing 24, and control the operation of the first controller 26 from a place remote from the printing module 25 of the second printer 22. In such away, users can hold the first controller 26 by hand to control printing and be closer to the display panel 30 of the first controller 26 so that the display panel 30 can be a smaller panel instead of a large-size panel according to the prior art.

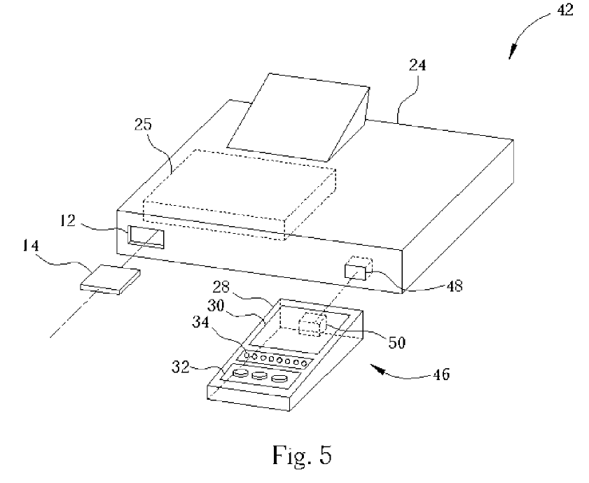

Please refer to FIG. 5. FIG. 5 is a diagram illustrating a third printer 42 according to the second embodiment of the present invention. The structure and components of the third printer 42 according to the second embodiment are essentially the same to the second printer 22 according to the first embodiment, therefore the numberings of the two embodiments are the same. The only difference is that the third printer 42 includes a first wireless transmitting module 48 connected to the printing module 25, and a second controller 46 connected to the processor 29 includes a second wireless transmitting module 50, for wirelessly exchanging data with the first wireless transmitting module 48. The first wireless transmitting module 48 and the second wireless transmitting module 50 apply a WLAN protocol such as IEEE 802.11b, Bluetooth™, or infrared transmission.

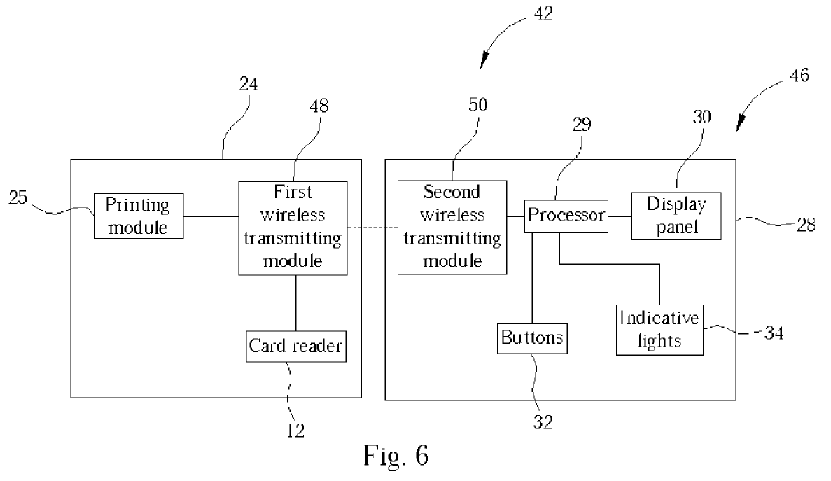

Please refer to FIG. 6. FIG. 6 is a block diagram of the third printer 42. The operation of the third printer 42 is essentially the same to the second printer 22. The only difference is that the second printer 22 reads the data from the card reader 14 and transmits signals to the printing module 25 through the first connecting port 36, the wire 40, and the second connecting port 38. The third printer 42, however, reads the data from the card reader 14 and transmits signals to the printing module 25 wirelessly using the first wireless transmitting module 48 and the second wireless transmitting module 50.

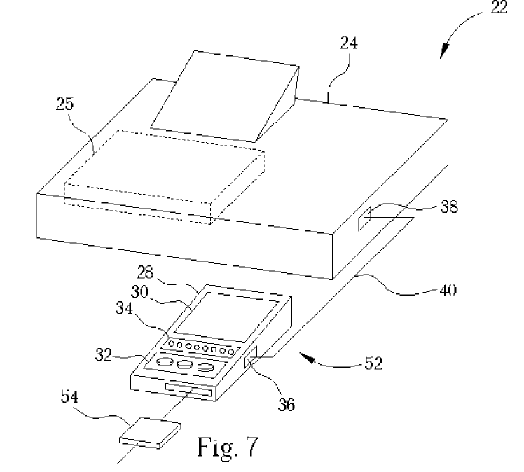

Please refer to FIG. 7. FIG. 7 is a diagram illustrating a third controller 52 according to another embodiment of the present invention. The difference between the third controller 52 and the controllers according to the previous embodiments mentioned above is that the third controller 52 includes a storage device 54 that can be detached installed on a second housing 28 for storing image data. The storage device 54 can be a read-only memory (ROM) or a flash memory that conforms to a standard such as CF, SD, or MMC. The third controller 52 can be applied with both the second printer 22 and the third printer 42, so that the image data to be printed can not only be read by the card reader 12 on the first housing 24 as mentioned above, but also read by the storage device 54 on the third controller 52 as described in this embodiment. In such a way it is possible to input the image data to be printed remotely instead of reading the image data by the printer itself increasing convenience. In this embodiment, it is also allowable to instal a single storage device 54 on the third controller 52 instead of also installing a card reader 12 on the first housing 24. In this way, the number of modules in the printer can be reduced, and the third controller 52 can be selected purchased by users. If printing image data from a computer is required, users can purchase a printer without the third controller 52. And if printing image data input by at the printer itself is required, users can purchase the third controller 52.

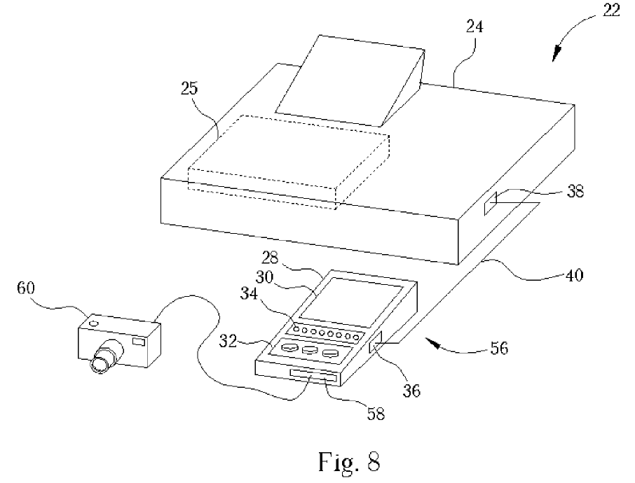

Please refer to FIG. 8. FIG. 8 is a diagram illustrating a fourth controller 56 according to another embodiment of the present invention. The difference between the fourth controller 56 and the controllers mentioned above is that the fourth controller 56 includes a third connecting port 58 connected to an image input device 60, such as a digital camera or a digital recorder. The transmission between the third connecting port 58 and the image input device 60 conforms to standards such as USB1.0, USB2.0 or IEEE1394. The fourth controller 56 can be applied with the second printer 22 and the third printer 42. In this way it is possible to input image data to be printed remotely by the image input device 60 to a printing module 25, which is similar to the third controller 52 already described above.

In contrast to the prior art, the printer according to the present invention is capable of receiving image data and corresponding commands from a remote control, so that not only convenience of printing is improved, but also users can be closer to the display panel on the remote control to see the images more clearly. A large-size display panel on the conventional printer can be replaced by a smaller display panel on the remote controller in order to reduce costs. It is another advantage of the present invention that if users require to print image data in combination with a computer or to edit images by professional graphic software in a photo laboratory or studio, the remote control can be switched into PC mode in order to allow the computer to directly edit or print the images. In the absence of a computer or in situations where a computer is not needed, users can utilize the remote control instead of the computer to edit, preview, and print the images in the memory card. Thus, the present invention is practical for users having different requirements according to a variety of conditions.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A printer comprising:
a first housing;
a printing module installed on the first housing for printing data; and
a controller comprising:
a second housing that can be detached installed on the first housing;
a processor installed in the second housing for processing programs and data; and
a display panel installed on the second housing and electrically connected to the processor for displaying data.

2. The printer of claim 1 wherein the controller further comprises a plurality of buttons installed on the second housing for inputting control signals.

3. The printer of claim 1 wherein the controller further comprises a touch panel installed on the display panel for inputting control signals.

4. The printer of claim 1 wherein the first housing comprises a first connecting port, the second housing comprises a second connecting port, and the printer further comprises a wire connected between the first connecting port and the second connecting port for electrically connecting the printing module to the processor of the controller.

5. The printer of claim 4 wherein the first connecting port and the second connecting port conform to the USB1.0 or USB2.0 standard.

6. The printer of claim 4 wherein the first connecting port and the second connecting port conform to the IEEE1394 standard.

7. The printer of claim 1 wherein the printer further comprises a first wireless transmitting module connected to the printing module, and the controller further comprises a second transmitting module connected to the processor for wirelessly exchanging data with the first transmitting module.

8. The printer of claim 7 wherein the first transmitting module and the second transmitting module utilize the IEEE 802.1 b WLAN protocol.

9. The printer of claim 7 wherein the first transmitting module and the second transmitting module utilize the Bluetooth™ WLAN protocol.

10. The printer of claim 7 wherein the first transmitting module and the second transmitting module transmit data by infrared.

11. The printer of claim 1 wherein the controller further comprises a storage device that can be detached installed on the second housing for storing data.

12. The printer of claim 11 wherein the storage device is a read-only memory (ROM).

13. The printer of claim 11 wherein the storage device is a flash memory.

14. The printer of claim 1 wherein the second housing further comprises a third connecting port for connecting an image input device.

15. The printer of claim 14 wherein the third connecting port conforms to USB1.0 or USB2.0 standard.

16. The printer of claim 14 wherein the third connecting port conforms to IEEE1394 standard.
